(19) United States
(12) Patent Application Publication
(10) Pub. No.: US 2004/0126508 A1
(43) Pub. Date: Jul. 1, 2004

(54) Image-recording medium

(76) Inventor: Yasuyuki Takeda, Yamagata (JP)

Correspondence Address: 3M INNOVATIVE PROPERTIES COMPANY, PO BOX 33427, ST. PAUL, MN, 55133-3427, US

(21) Appl. No.: 10/362,802

(22) PCT Filed: Aug. 9, 2001
(86) PCT No.: PCT/US01/24960

(51) Int. Cl. B41M 5/00

(52) U.S. Cl. 428/32.1

(57) ABSTRACT

To provide an image-recording medium, which has increased adhesion between an image-receptive layer and a retroreflective sheet, can easily increase the outdoor durability including water resistance, and can effectively increase the retroreflection luminance of an image-recorded surface. An image-recording medium comprising a retroreflective sheet as a substrate and an image-receptive layer which is provided on the reflective side of said retroreflective sheet and receives printing inks, wherein said image-receptive layer contains the first polymer, said retroreflective sheet has a covering layer contains the second polymer, and said image-receptive layer is fixed to the surface of said covering layer, characterized in that said medium further comprises a primer layer which is provided between said covering layer and said image-receptive layer and contains the third polymer having a compatibility with both the first and second polymers, and that a reflection luminance measured on the surface of said image-receptive layer is at least 30 cd/lx/m2.

### BACKGROUND OF THE INVENTION

1. Field of the Invention

The present invention relates to an image-recording medium which can impart the retroreflectivity to an image-recorded surface. The image-recording medium of the present invention has improved durability (e.g. water resistance, adhesion between an image-receptive layer and a retroreflective sheet, etc.) so that the medium can be used outdoors.

2. Background of the Invention

A conventional image-recording medium comprises a laminated sheet of an opaque substrate and an image-receptive layer provided on one surface of the substrate. In general, the image-receptive layer contains a polymer, and as such a polymer, one having a high affinity with printing inks is selected to facilitate the image recording (the reception of images) by printing. For example, the images are printed with aqueous inks by an ink-jet printing method.

One example of the image-recording medium used in the ink-jet printing method is disclosed in JP-A-10-181189. The disclosed image-recording medium has an image-receptive layer which comprises a polyurethane resin emulsion having a polycarbonate chain in the molecule and an average particle size of 3.0 μm or less. Thus, the disclosed image-recording medium has good ink-jet printing properties, and is used as a medium for off-set printing, thermal transfer printing, color laser printing, etc.

The above polyurethane resin is preferably a polyurethane resin having a sulfonic acid group in the molecule. When the sulfonic acid group-containing polyurethane resin is used, the curling of the sheet (the image-recording medium) can be effectively prevented after the coating of the image-receptive layer.

Alternatively, a cation-modified polyurethane may be used as a polymer contained in the image-receptive layer. Specific examples of the cation-modified polyurethane include PATERACOL® IJ-170 (a coating containing a cation-modified polyurethane and inorganic fine powder), PATERACOL® IJ-21 (a coating containing a cation-modified polyurethane but no inorganic fine powder) (both manufactured by DAINIPPON INK & CHEMICALS, Inc.), and so on. Here, the inorganic fine powder is used to increase the porosity of the image-receptive layer. However, the inorganic fine powder tends to decrease the transparency of the image-receptive layer.

In general, the opaque substrate used in the above image-recording medium is a paper sheet or a porous polymer film, while an image-recording medium is known, which comprises a retroreflective sheet as a substrate and has the retroreflectivity. Such a retroreflective image-recording medium is disclosed in, for example, JP-A-61-135784. The image-receptive layer disclosed in this JP-A publication contains a water-soluble resin such as polyvinyl alcohol, polyvinylpyrrolidone, etc. to improve the printing properties with aqueous inks. However, the image-receptive layer containing such a water-soluble resin has the insufficient outdoor durability (water resistance) of printed images, even if a transparent covering film is laminated over the surface of the images to protect the printed images (printed layer).

### SUMMARY OF THE INVENTION

Meanwhile, it has been revealed by the present inventors that the image-receptive layer containing the above-described polyurethane resin is advantageous to improve the ink-setting properties with aqueous inks and also the outdoor durability (water resistance) of the images.

However, when a retroreflective sheet is used as a substrate in place of the above-described porous substrate which is commonly used, the adhesion between the image-receptive layer and the surface of the retroreflective sheet decreases. As a result, it is difficult to increase the durability so that the medium can withstand the outdoor use (outdoor durability) for the following reason:

A conventional retroreflective sheet has a covering layer containing a polymer, and in the case of an image-recording medium having, the retroreflective sheet as the substrate, the image-receptive layer is fixed to the surface of the covering layer. In general, the polymer contained in the covering layer is an acrylic polymer, polyethylene terephthalate (PET), a vinyl chloride polymer, etc. In such a case, the affinity between the polymer contained in the image-receptive layer and the polymer of the above covering layer is not always high. Thus, the adhesion between the image-receptive layer and the surface of the covering layer of the retroreflective sheet is low, and therefore the outdoor durability is hardly increased.

One object of the present invention is to provide an image-recording medium, which has the increased adhesion between an image-receptive layer and a retroreflective sheet, can easily increase the outdoor durability including water resistance, and can effectively increase the retroreflection luminance of the surface carrying the recorded images (image-recorded surface).

To solve the above problems, the present invention provides an image-recording medium comprising (1) a retroreflective sheet as a substrate and (2) an image-receptive layer which is provided on the reflective side of said retroreflective sheet and receives printing inks, wherein said image-receptive layer contains the first polymer, said retroreflective sheet has a covering layer contains the second polymer, and said image-receptive layer is fixed to the surface of said covering layer, characterized in that said medium further comprises a primer layer which is provided between said covering layer and said image-receptive layer and contains the third polymer having a compatibility with both the first and second polymers, and that a reflection luminance measured on the surface of said image-receptive layer is at least 30 cd/lx/m².

### DETAILED DESCRIPTION OF THE INVENTION

Image-Recording Medium

The image-recording medium of the present invention has a structure comprising (1) a retroreflective sheet as a substrate, and (2) an image-receptive layer which is provided on the reflective side of said retroreflective sheet and receives printing inks. The image-receptive layer contains the first polymer, the retroreflective sheet has a covering layer contains the second polymer, and the image-receptive layer is fixed to the surface of the covering layer. One of the characteristics of the present invention is that a specific primer layer is provided between the covering layer of the retroreflective sheet and the image-receptive layer. The primer layer contains the third polymer having a compatibility with both the first and second polymers. Thus, the adhesion between the image-receptive layer and the retroreflective sheet (interlaminar adhesion) is improved.

When the affinity of the primer with the covering layer of the retroreflective layer and the image-receptive layer is low, the transparency of the laminate of the covering layer, the primer layer and the image-receptive layer tends to deteriorate due to the decrease of the interlaminar adhesion. As a result, the inherent reflection luminance of the retroreflective sheet is deteriorated, and thus the reflection luminance of the image-recorded surface cannot be effectively increased. Accordingly, the affinity of the first, second and third polymers should be increased by the selection of these polymers so that the reflection luminance measured on the surface of the image-receptive layer prior to the recording of the images is at least 30 cd/lx/m². The reflection luminance measured on the surface of the image-receptive layer is preferably at least 50 cd/lx/m², more preferably at least 80 cd/lx/m². The upper limit of the reflection luminance is preferably at a level such that the mirror surface appearance, which interferes with the visibility of the images, is not imparted to the image-recording surface. Accordingly, the reflection luminance is usually 500 cd/lx/m² or less, preferably 400 cd/lx/m² or less, more preferably 300 cd/lx/m² or less.

Herein, the “reflection luminance” is measured with a reflection luminance meter (retroreflectometer).

It should be avoided to compound a relatively large amount of a material having shielding properties such as inorganic powder in the image-receptive layer and to decrease the transparency of the image-receptive layer itself.

Accordingly, the haze (turbidity) of the image-receptive layer, which is measured with a color meter, is preferably 30% or less, more preferably 20% or less.

A light transmittance is not limited, and is usually at least 85%, preferably at least 90%. Herein, the “light transmittance” means a total light transmittance, which is measured with a spectrophotometer or a color meter having a spectrometric function using light having a wavelength of 550 nm.

Image-Receptive Layer

Preferably, the image-receptive layer contains a polymer which can improve the water resistance of the images as the first polymer. For example, the first polymer is preferably an ion-modified polyurethane such as a cation-modified polyurethane. The image-receptive containing the ion-modified polyurethane is advantageous to increase the water resistance of the ink-jet printed images in particular. In this case, the outdoor durability of the images can be effectively improved only by the adhesion of a transparent covering film (overlamination film) to cover the image-recording surface without an edge-seal treatment.

When the image-receptive layer contains a polymer having low water resistance (e.g. the above-described water-soluble resin such as polyvinyl alcohol, etc.), water tends to penetrate in the interface between the transparent covering film and the image-receptive layer from the edges, even if the transparent covering film is over-laminated. Accordingly, when the image-recording medium is used outdoors, the edge-seal treatment (adhesion of a transparent adhesive tape, etc.) is required. However, the image-receptive layer containing the ion-modified polyurethane can increase the outdoor durability in the absence of the edge-seal treatment. As the ion-modified polyurethane, the above-described commercially sold products can be used.

The polyurethane is a polymer prepared from a raw material containing a polyol (a polymer or an oligomer having at least 2 hydroxyl groups in the molecule) and a diisocyanate. In general, the polyol and/or the diisocyanate as the raw materials contain an ionic functional group in the molecule.

Specific examples of the polyol include polyester polyol, polyether polyol, polycaprolactone polyol, acrylic polyol, polycarbonate polyol, etc. Usually, a single polyol or a mixture of two ore more polyols may be used. Specific examples of the diisocyanate include isophorone diisocyanate, TDI (tolylene diisocyanate), MDI (diphenylmethane diisocyanate), hydrogenated MDI, 1,6-hexanediol diisocyanate, etc. In general, a single diisocyanate or a mixture of two or more diisocyanate may be used.

The above raw materials may contain a chain extender such as ethylene glycol, butanediol, neopentyl glycol, 1,1,1-trimethylolpropane, etc.

The image-receptive layer may optionally contain a water-soluble salt (a salt of an organic or inorganic acid) as a coagluating agent. The coagulating agent coagulates the inks on the surface of the image-receptive layer and improves the quick drying properties, when the aqueous inks are applied (printed) on the surface of the medium.

The thickness of the image-receptive layer is preferably from 5 to 200 μm, more preferably from 10 to 100 μm. When the image-receptive layer is too thin, the ink-absorbing absorbing ability is insufficient so that the color development of the images decreases. When the image-receptive layer is too thick, the surface area of the edge part unnecessarily increases so that the water resistance tends to decrease, and thus the edge seal treatment may be necessary in the case of outdoor use of the image-recording medium.

The image-receptive layer may be formed by applying a liquid containing the second polymer and drying it. In this case, water or an alcohol is preferably used as a solvent. As an application means, a conventional coater such as a bar coater, a knife coater, a roll coater, a die coater, etc. can be used.

Primer Layer

The third polymer in the primer layer is selected so that it has the affinity with both the second polymer in the covering layer and the first polymer in the image-receptive layer.

Preferably, the third polymer in the primer layer is an aminoethylated polymer, when the first polymer is the ion-modified polyurethane and the second polymer is an acrylic polymer. This combination of the polymers can increase the water resistance of the images recorded with the aqueous inks and also the adhesion of the image-receptive layer and the retroreflective sheet so that the outdoor durability is particularly increased. Accordingly, the image-recording medium can be used outdoors for a long time only by the provision of the transparent covering film on the surface of the image-receptive layer without the edge-seal treatment. In addition, the retroreflection luminance can be particularly easily increased.

The aminoethylated polymer means a polymer in which a primary amino group (—NH₂) is introduced using ethyleneimine. This reaction is named “aminoethylation” when the primary amino group is introduced by ring opening and adding ethyleneimine to the polymer. Thus, in this specification, the polymer having the primary amino group in the molecule, which is obtained by such a method, is named an aminoethylated polymer or resin.

When the first polymer is the ion-modified polyurethane and the second polymer is the vinyl chloride polymer, the third polymer in the primer layer is preferably the saturated polyester for the same reason as described above.

Furthermore, when the first polymer is the ion-modified polyurethane and the second polymer is polyethylene terephthalate, the third polymer in the primer layer is preferably the saturated polyester for the same reason as described above.

As the saturated polyester, a linear polyester is preferable, in particular, one having Tg higher than 50° C. The saturated polyester may be crosslinked with a crosslinking agent such as an isocyanate compound insofar as the effects of the present invention are not impaired.

When the first polymer is the ion-modified polyurethane and the third polymer is the urethane elastomer, the adhesion between the primer layer and the image-receptive layer is effectively increased. In this case, the adhesion between the covering layer and the primer layer may not be effectively increased according to the kind of the second polymer in the covering layer of the retroreflective sheet. In such a case, the blend of the urethane elastomer and other polymer is used to form the primer layer so that the adhesion between the covering layer containing such a second polymer and the image-receptive layer containing the ion-modified polyurethane can be increased.

Such a urethane elastomer is an elastomer of polyurethane prepared by polymerizing the raw materials such as the above described polyol, diisocyanate, etc.

In the above cases, the saturated polyesters, the aminoethylated polymers and the urethane elastomers may be used independently or as a mixture of two or more. For example, the combination of the aminoethylated polymer and the urethane polymer has particularly good affinity to the acrylic polymer. In this combination, the weight ratio of the aminoethylated polymer (Am) to the urethane elastomer (PU) (Am:PU) is preferably from 50:50 to 90:10, more preferably from 60:40 to 87:13.

The thickness of the primer layer is usually from 0.1 to 30 μm, preferably from 0.5 to 10 μm. When the thickness of the primer layer is too thin, the adhesion between the retroreflective sheet and the image-receptive layer may decrease. When the thickness of the primer layer is too large, the primer layer may be discolored by the outdoor exposure to UV ray for a long time, so that the appearance of the recorded images may be deteriorated.

For example, the primer layer can be formed by applying a liquid containing the third polymer and drying it. As an application means, a conventional coater such as a bar coater, a knife coater, a roll coater, a die coater, etc. can be used.

Retroreflective Sheet

In general, the covering layer of the retroreflective sheet contains the acrylic polymer, the vinyl chloride polymer or polyethylene terephthalate.

The acrylic polymer may be usually a homopolymer of an alkyl methacrylate such as methyl methacrylate, ethyl methacrylate, etc. Also, a copolymer prepared by polymerizing a monomer mixture containing the alkyl acrylate and other copolymerizable monomer may be used. In this case, the content of the alkyl acrylate in the monomer mixture is usually at least 55 wt. %. Examples of the copolymerizable monomer include (meth)acrylic monomers other than alkyl methacrylates (e.g. alkyl acrylates, alkoxyalkyl metchacrylates, etc.); unsaturated monomers other than the (meth)acrylate monomers (e.g. olefins such as ethylene, styrene, styrene derivatives, etc.); macromers having a polymerizable functional group such as a vinyl group on at least one end of the molecule, and so on.

The acrylic polymer may be used in the form of a blend with other polymer such as polycarbonate, polyvinylidene fluoride, etc. In this case, the content of the acrylic polymer in the polymer blend is usually at least 55 wt. %, preferably at least 60 wt. %.

The vinyl chloride polymer is usually a vinyl chloride homopolymer. Furthermore, a copolymer prepared by polymerizing a monomer mixture containing vinyl chloride and other copolymerizable monomer may be used. In this case, the content of vinyl chloride in the monomer mixture is usually at least 55 wt. %. Examples of the copolymerizable monomer used in the preparation of the vinyl chloride copolymer include the above-mentioned (meth)acrylate monomers, unsaturated monomers other than the (meth)acrylate monomers, macromers, etc.

The vinyl chloride polymer may be used in the form of a blend with other polymer such as the above acrylic polymer, an ethylene-vinyl acetate copolymer, an ABS resin, a MBS resin, chlorinated polyethylene, a NBR resin, etc. In this case, the content of the vinyl chloride polymer in the polymer blend is usually at least 55 wt. %, preferably at least 60 wt. %.

Polyethylene terephthalate can be used singly or as a blend with other polymer(s). Examples of the other polymer include polyethylene naphthalate (including so-called Co-PEN), polycarbonate, etc. In the case of the blend, the content of polyethylene terephthalate in the polymer blend is usually at least 55 wt. %, preferably at least 60 wt. %.

As the retroreflective sheet having the above covering layer, an encapsulated bead lens type one (simply referred to as “encapsulated lend type”), a prism lens type one, an embedded bead lens type one, etc. may be used.

The encapsulated bead lens type retroreflective sheet comprises a binder layer which carries, on its surface, a plurality of transparent bead lenses, and has a structure such that the light-incident surfaces of the bead lenses are exposed and the bead lenses are encapsulated between the light-transmitting covering layer and the binder layer.

The prism lens type retroreflective sheet comprises a light-transmitting covering layer which carries, on its back surface, a plurality of prism lenses such as cube corner prisms, and has a structure such that the surface of the prism lenses are exposed and the prism lenses are encapsulated between the covering layer and the binder layer. The second covering layer can be laminated on the surface of the above covering layer, and the primer layer can be formed on the surface of the second covering layer.

The embedded bead lens type retroreflective sheet comprises a binder layer which carries, on its surface, a plurality of transparent bead lenses, and a light-transmitting covering layer which covers the bead lenses so that their light-incident surfaces are not exposed. The second covering layer can be laminated on the surface of the above covering layer, and the primer layer can be formed on the surface of the second covering layer.

Any commercially sold retroreflective sheet may be used as the retroreflective sheet having the covering layer. Specific examples of the commercially sold retroreflective sheet include “DIAMOND GRADE SERIES” prism lens type retoreflective sheets, “HIGH INTENSITY GRADE SERIES” encapsulated lens type retroreflective sheets, and “ENGINEER GRADE SERINS” embedded lens type retroreflective sheet (all available from 3M, USA).

The reflection luminance of the retroreflective sheet is usually at least 35 cd/lx/m², preferably at least 80 cd/lx/m².

Applications of Image-Recording Media

The image-recording media of the present invention may be used to produce image-recorded retroreflective sheets (retroreflective sheets having the recorded images) by recording the images on the sheets with aqueous inks using a printer such as an ink-jet printer, etc.

In general, the aqueous inks comprise a colorant such as a pigment or a dye, and a solvent such as water, alcohol, etc. The recording media of the present invention have particularly good effects in the recording with the ink-jet printer using the aqueous inks (comprising water as the solvent). The printing conditions are not critical, and may be the same as those employed to print a recording paper.

The image-recording retroreflective sheet of the present invention may be used as a material of a traffic sign, a decorative sheet, etc. For example, an adhesive layer comprising an adhesive, etc. is applied on the surface of the retroreflective sheet opposite to the image-receptive surface of the retroreflective sheet, and a liner is provided to protect the adhesive surface of the adhesive layer to form a laminate comprising the recording medium, the adhesive layer and the liner. The liner is supplied to a printer in the same way as in the case of a simple recording medium to print the images on the image-receptive surface of the recording medium (the surface of the image-receptive layer). The produced image-recording media may be adhered to adherents such as substrates of signs, substrates of signboards, walls, automobile bodies, panes, etc.

When the image-receptive layer comprises the ion-modified polyurethane, the water resistance of the images recorded with the aqueous inks can be improved. Thus, the image-recording media require no edge-sealing treatment, and can be used outdoors for a long time only by the application of the transparent covering film on the image-receptive surface (image-recorded surface).

That is, the present invention can provide an image-displaying member having the retroreflectivity, which can be installed outdoors and comprises the adherent, the image-recording retroreflective sheet provided on the surface of the adherent, and the transparent covering film provided on the image-recorded surface of the retroreflective sheet. Such an image-displaying member can maintain the images for a long time without the deterioration of the appearance, and can effectively increase the retroreflective luminance.

As the transparent covering film, a film used in the lamination applications may be used. The covering film usually comprises a polymeric substrate of an acrylic polymer a vinyl chloride polymer, polyester (e.g. PET, etc.), polyurethane, and so on. The transparent covering film is generally adhered to the image-recorded surface with an adhesive comprising an acrylic polymer.

### EXAMPLES

The image-recording media produced in Examples and Comparative Examples were evaluated with respect to the following properties.

Here, the evaluation methods of those properties are explained.

Turbidity and Total Light Transmittance of Image-Receptive Layer

A film consisting of an image-receptive layer alone was prepared as described below, and used as a sample film.

Firstly, a coating composition for forming an image-receptive layer used in each example was applied on a PET substrate and dried under the same conditions as those employed in the production of an image-recording medium to form a coated film. Then, the coated film was removed from the PET substrate to obtain the sample of the coated film. With the film formed from the coating composition used in each example, the turbidity and the total light transmittance were measured with the color meter Σ90 (manufactured by Nippon Denshoku Kabushikikaisha).

Reflection Luminance

The image-recording medium produced in each example was used as a test sample, and its reflection luminance was measured with the Retroreflectometer Model 920 (manufactured by GAMMA SCIENTIFIC).

Adhesion Between Retroreflective Sheet and Image-Receptive Layer

The cross-hatch cuts with a distance of about 2 mm were formed with a cutter on the surface of the image-receptive layer of the image-recording medium produced in each example, and the medium just after the formation of the cross-hatch cuts, and one that was heated at 65° C. for 14 days from the formation of the cross-hatch cuts were used as samples.

Then, a peeling test was carried out by adhering a mending tape No. 810 (manufactured by 3M, USA) to the cross-hatched surface of the image-receptive layer, and quickly peeling off the mending tape with a hand to evaluate the degree of difficulty to peel off the image-receptive layer.

Printability

An image was printed on the image-recording medium produced in each example using an actually used printer under the following conditions, and the quality of the printed image was visually evaluated.

Printer: Novajet III (manufactured by Encad)

Printing direction: single direction

Number of passes: 4 passes

Ink jetting rate: 5000 Hz

Used inks: Aqueous pigment inks manufactured by 3M, USA (855 Series: Yellow, Magenta, Cyan and Black)

Water Resistance of Recorded Image

The image was printed on the image-recording medium produced in each example in the same manner as in the printability test. Then, a transparent covering film (an overlamination film for ink-jet media: IJ 4116 manufactured by 3M, USA) was laminated on the printed surface of the medium, and the medium was adhered to an aluminum plate with an adhesive. The medium was maintained at room temperature (about 25° C.) and an atmospheric humidity (about 65% RH) for 24 hours, and used as a test sample. The test sample was dipped in warm water (40° C.) for 3 hours, and the appearance of the image (e.g. the flow of the ink, etc.) was observed.

Weather Resistance

The test sample, which was produced in the same manner as in the water resistance test, was exposed outdoors at an angle of 90 degrees for six months, and the change of the appearance was observed.

Now, Examples and Comparative Examples are explained.

### Example 1

This Example used an encapsulated bead lenses type retroreflective sheet having a covering layer of a polymer blend film comprising a vinyl chloride polymer and an acrylic polymer.

On the covering layer of the above retroreflective sheet, a coating composition comprising a saturated linear polyester (Vylon® 24 SS manufactured by Toyobo Co., Ltd.) was applied and dried at 100° C. for 2 hours to form a primer layer having a thickness of 3 μm.

On the primer layer, a coating composition comprising a cation-modified polyurethane (PATERACOL® IJ-21 manufactured by DAINIPPON INK & CHEMICALS, Inc.) was applied and dried at 115° C. for 3 minutes to form an image-receptive layer having a thickness of 20 μm. Thus, the image-recording medium having the retroreflectivity was obtained.

With the image-recording medium of this Example, the above properties were evaluated as described above. The results are as follows:

Turbidity of image-receptive layer: 9.6%

Total light transmittance of image-receptive layer: 90.6%

Reflection luminance: 92 cd/lx/m²

Adhesion of image-receptive layer: No peeling of the image-receptive layer after the peeling test.

Printability: Color densities being high and substantially no blur at the boundaries between the inks of different colors

Water resistance: No change of appearance

Weather resistance: Neither the change of appearance nor peeling of the transparent covering film being observed.

### Comparative Example 1

An image-recording medium having the retroreflectivity was produced in the same manner as in Example 1 except that no primer layer was formed. However, the adhesion of the image-receptive layer was insufficient from the beginning, and this medium was judged that it could not be used outdoors.

### Example 2

This Example used an encapsulated bead lenses type retroreflective sheet having a covering layer of polyethylene terephthalate.

An image-recording medium was produced in the same manner as in Example 1 except that the retroreflective sheet was changed.

With the image-recording medium of this Example, the above properties were evaluated as described above. The results are as follows:

Turbidity of image-receptive layer: 9.6%

Total light transmittance of image-receptive layer: 90.6%

Reflection luminance: 247 cd/lx/m²

Adhesion of image-receptive layer: No peeling of the image-receptive layer after the peeling test

Printability: Color densities being high and substantially no blur at the boundaries between the inks of different colors

Water resistance: No change of appearance

Weather resistance: Neither the change of appearance nor peeling of the transparent covering film being observed

### Comparative Example 2

An image-recording medium having the retroreflectivity was produced in the same manner as in Example 2 except that no primer layer was formed. However, the adhesion of the image-receptive layer was insufficient from the beginning, and this medium was judged that it could not be used outdoors.

### Example 3

This Example used an encapsulated bead lenses type retroreflective sheet having a covering layer of an acrylic film containing polymethyl methacrylate.

An image-recording medium was produced in the same manner as in Example 1 except that the retroreflective sheet and a primer layer were changed.

In this Example, as a coating composition for forming a primer layer, a mixture of a coating composition containing an aminoethylated resin (NK-350 manufactured by Nippon Shokubai Co., Ltd.) and another coating composition containing a urethane elastomer (Spenzol® L44 manufactured by DAINIPPON INK & CHEMICALS, Inc.) in a weight ratio of 85:15 was used. The drying was carried out at 80° C. for 2 minutes to form the primer layer having a thickness of 4 μm.

With the image-recording medium of this Example, the above properties were evaluated as described above. The results are as follows:

Turbidity-of image-receptive layer: 9.6%

Total light transmittance of image-receptive layer: 90.6%

Reflection luminance: 238 cd/lx/m²

Adhesion of image-receptive layer: No peeling of the image-receptive layer after the peeling test

Printability: Color densities being high and substantially no blur at the boundaries between the inks of different colors

Water resistance: No change of appearance

Weather resistance: Neither the change of appearance nor peeling of the transparent covering film being observed

### Comparative Example 3

An image-recording medium having the retroreflectivity was produced in the same manner as in Example 3 except that no primer layer was formed. However, the adhesion of the image-receptive layer was insufficient from the beginning, and this medium was judged that it could not be used outdoors.

### A Comparative Example 4

An image-recording medium having the retroreflectivity was produced in the same manner as in Example 3 except that the coating composition for forming the image-receptive layer was changed to one described below.

The coating composition for forming the image-receptive layer was prepared by mixing 90 wt. % of the coating composition containing the cation-modified polyurethane (PATERACOL® IJ-21) and 10 wt. % of the coating containing a cation-modified polyurethane but no inorganic fine powder (PATERACOL® IJ-170).

With the image-recording medium of this Example, the above properties were evaluated as described above. The results are as follows:

Turbidity of image-receptive layer: 50.4%

Total light transmittance of image-receptive layer: 89.4%

Reflection luminance: 12.4 cd/lx/m²

Adhesion of image-receptive layer: No peeling of the image-receptive layer after the peeling test

Printability: Color densities being high and substantially no blur at the boundaries between the inks of different colors

Water resistance: No change of appearance

Weather resistance: Neither the change of appearance nor peeling of the transparent covering film being observed

The turbidity of the image-receptive layer decreased, and the retroreflectivity (luminance) greatly decreased. Thus, the medium had insufficient usefulness.

1. An image-recording medium comprising (1) a retroreflective sheet as a substrate and (2) an image-receptive layer which is provided on the reflective side of said retroreflective sheet and receives printing inks, wherein said image-receptive layer contains the first polymer, said retroreflective sheet has a covering layer contains the second polymer, and said image-receptive layer is fixed to the surface of said covering layer,
characterized in that said medium further comprises a primer layer which is provided between said covering layer and said image-receptive layer and contains the third polymer having a compatibility with both the first and second polymers, and that a reflection luminance measured on the surface of said image-receptive layer is at least 30 cd/lx/m².

2. The image-recording medium according to claim 1, wherein said first polymer is an ion-modified polyurethane, said second polymer is an acrylic polymer, and said third polymer is an aminoethylated polymer.

3. The image-recording medium according to claim 1, wherein said first polymer is an ion-modified polyurethane, said second polymer is a vinyl chloride polymer, and said third polymer is a saturated polyester.

4. The image-recording medium according to claim 1, wherein said first polymer is an ion-modified polyurethane, said second polymer is polyethylene terephthalate, and said third polymer is a saturated polyester.
